(19) United States
(12) Patent Application Publication
(10) Pub. No.: US 2004/0087702 A1
(43) Pub. Date: May 6, 2004

(54) Polymer-modified clay moulding

(76) Inventors: Mario Sandor, Obrigheim (DE); Manfred Schwartz, Frankenthal (DE); Bertold Bechert, Grunstadt (DE); Joachim Pakusch, Speyer (DE); Hans-Jurgen Denu, Friedelsheim (DE); Dietbert Knofel, Siegen (DE); Karl-Georg Bottger, Siegen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/362,516

(22) PCT Filed: Sep. 3, 2001
(86) PCT No.: PCT/EP01/10133

(30) Foreign Application Priority Data
Sep. 4, 2000 (DE) 100 43 453.3

(51) Int. Cl. C08K 3/34

(52) U.S. Cl. 524/445

(57) ABSTRACT

Clay moldings comprise a mineral material based on clay minerals as the main component and at least one hydrophopic, film-forming polymer uniformly distributed in the molding.

The present invention relates to clay moldings which are modified with polymers, and a process for their production.

Clay moldings are understood as meaning three-dimensional structures which comprise a mineral material and contain a clay mineral as the main component. Clay mineral-containing moldings are known from the prior art also as clay ceramics, clay ceramic products or products of clay ceramic materials (cf. Ullmanns Enzyklopädie der Technischen Chemie, 4th edition, Vol. 13, page 712).

Clay ceramic products of the prior art are produced as a rule by bringing a water-containing, plastically deformable or flowable, clay mineral-containing mineral material or a moist clay mineral-containing powder into the desired form, removing the water in a drying process and calcining the molding thus obtained to give the actual ceramic material at above 900° C. As a result of this calcination process, the clay ceramic materials acquire their actual strength.

Clay ceramic materials have high chemical inertness, for example to weathering influences. For this reason, building materials, such as building blocks, for example roof building blocks, such as roof tiles, pipes, for example for waste water, acid-resistant blocks and construction ceramics, have long been produced from clay ceramic materials.

Clay ceramic materials or moldings comprising clay ceramic materials, in particular comprising coarse clay ceramic materials, have, however, the disadvantage of low compressive strength and bending tensile strength and low elasticity. As a result of this, they are damaged under mechanical stress, for example they break or flake off at their surfaces. For example, clay roof building blocks are frequently damaged or even destroyed by hail.

It is an object of the present invention to provide novel moldings which are based on clay minerals and have an improved mechanical property profile.

We have found that this object is achieved, surprisingly, if a formulation which contains a uniformly distributed hydrophobic, film-forming polymer in addition to a mineral material based on clay minerals as the main component is used for the production of the moldings. Clay moldings which contain a uniformly distributed hydrophobic, film-forming polymer are obtained here. Here, uniformly distributed means that the polymer does not form any closed domains which are substantially larger than the size of the microstructure of the components of the clay minerals.

Accordingly, the present invention relates to a clay molding which contains a mineral material based on one or more clay minerals as the main component and at least one hydrophobic film-forming polymer uniformly distributed in the molding.

Mineral materials based on clay minerals is understood as meaning materials comprising mineral components which contain at least one clay mineral, such as kaolinite, illite, halloysite and montmorillonite, as the main component, i.e. in amounts of >50, particularly >80, % by weight, and, if required, silicates differing therefrom, silicas, aluminosilicates, such as feldspars, calcium carbonate, quartz sand etc., as secondary components. Such materials are commercially available as clays. A preferred embodiment of the invention relates to a molding based on illitic clay.

The present invention relates both to moldings comprising fine clay having particle sizes of <2 μm and to moldings comprising coarse clay or silt having particle sizes of from 2 to 20 μm (cf. Ullmanns Enzyklopädie der Technischen Chemie, 3rd edition, Vol. 17, page 484). A further preferred embodiment of the invention relates to moldings comprising a clay ceramic material, wherein the maximum size of the microstructure of the mineral components exceeds 0.2 mm and which are also referred to as coarse ceramic products. Such materials are used in particular for the production of roof building blocks. Here, roof building blocks are understood as meaning not only the conventional pantiles but also gable tiles, ridge tiles, stepped tiles, air bricks and other clay roof elements used for the covering of roofs.

The polymers used according to the invention for modifying the clay minerals are film-forming. This is understood as meaning that the polymer particles of the film-forming polymer coalesce into a polymeric film at a temperature which is below the production temperature of the molding. The temperature above which film formation occurs is also referred to as the minimum film formation temperature (MFT).

Uniform film formation of the hydrophobic polymer used in the production of the molding is as a rule ensured when the glass transition temperature T_{g} of the polymer is below 80° C., preferably below 50° C. Here, the glass transition temperature is understood as meaning the mid-point temperature determined according to ASTM D3418-82 by differential thermal analysis (DSC) (cf. Zosel, Farbe und Lack 82 (1976), 125-134, and DIN 53765). For sufficient strength of the novel molding, it is advantageous if the glass transition temperature of the polymer is at least −20° C., in particular at least 0° C. With regard to the elasticity, it is also advantageous if the glass transition temperature T_{g} does not exceed 50° C., in particular 30° C. The glass transition temperature of polymers which are composed of ethylenically unsaturated monomers can be controlled in a known manner by means of the monomer composition (T. G. Fox, Bull. Am. Phys. Soc. (Ser. II) 1, [1956], 123, and Ullmanns Encyclopedia of Industrial Chemistry, 5th edition, Vol. A21, Weinheim (1989), page 169).

In order to achieve sufficient strength of the molding, it is as a rule necessary for it to contain at least 0.2, preferably at least 0.5, in particular at least 1, part by weight, based on 100 parts by weight of mineral components, of hydrophobic, film-forming polymers. As a rule, amounts above 20 parts by weight, based on 100 parts by weight of mineral components, will not be necessary. Preferably, the molding contains not more than 15, in particular not more than 10, particularly preferably not more than 5, parts by weight, based on 100 parts by weight of mineral components, of the hydrophobic, film-forming polymer.

According to the invention, the polymer used is hydrophobic. Such polymers are insoluble in water and their polymer films have only low water absorption, i.e. below 40, in particular below 30, g/100 g of polymer film. Typical hydrophobic polymers are composed of ethylenically unsaturated monomers M which, as a rule, comprise at least 80, in particular at least 90, % by weight of ethylenically unsaturated monomers A having a water solubility of <60, in particular <30 g/l (25° C. and 1 bar), it being possible for up to 30, e.g. from 5 to 25, % by weight of the monomers A to be replaced by acrylonitrile and/or methacrylonitrile. In addition, the monomers A also contain from 0.5 to 20% by weight of monomers B differing from the monomers A. Hereinbelow, all quantity data for monomers in % by weight are based on 100% by weight of monomers M.

Monomers A are as a rule monoethylenically unsaturated or conjugated diolefins. Examples of monomers A are:

esters of an α,β-ethylenically unsaturated C₃-C₆-monocarboxylic acid or C₄-C₈-dicarboxylic acid with a C₁-C₁₀-alkanol. Preferably, they are esters of acrylic acid or methacrylic acid, such as methyl (meth)acrylate, ethyl (meth)acrylate, n-butyl(meth)acrylate, tert-butyl (meth)acrylate, 2-ethylhexyl (meth)acrylate etc.;

vinyl aromatic compounds, such as styrene, 4-chlorostyrene, 2-methylstyrene etc.;

vinyl esters of aliphatic carboxylic acids of, preferably, 1 to 10 carbon atoms, such as vinyl acetate, vinyl propionate, vinyl laurate, vinyl stearate, vinyl versatate etc;

olefins, such as ethylene or propylene;

conjugated diolefins, such as butadiene or isoprene;

vinyl chloride or vinylidene chloride.

Preferred film-forming polymers are selected from the polymer classes I to IV mentioned below:

I) copolymers which contain, as monomer A, styrene and at least one C₁-C₁₀-alkyl ester of acrylic acid, and if required, one or more C₁-C₁₀-alkyl esters of methacrylic acid as polymerized units;

II) copolymers which contain, as monomer A, styrene and at least one conjugated diene and, if required, (meth)acrylates of C₁-C₈-alkanols, acrylonitrile and/or methacrylonitrile as polymerized units;

III) copolymers which contain, as monomers A, methyl acrylate, at least one C₁-C₁₀-alkyl ester of acrylic acid and, if required, a C₂-C₁₀-alkyl ester of methacrylic acid as polymerized units;

V) copolymers which contain, as monomer A, at least one vinyl ester of an aliphatic carboxylic acid of 2 to 10 carbon atoms and at least one C₂-C₆-olefin and, if required, one or more C₁-C₁₀-alkyl esters of acrylic acid and/or of methacrylic acid as polymerized units.

Typical C₁-C₁₀-alkyl esters of acrylic acid in the copolymers of classes I to IV are ethyl acrylate, n-butyl acrylate, tert-butyl acrylate, n-hexyl acrylate and 2-ethylhexyl acrylate.

Typical copolymers of class I contain, as monomers A, from 20 to 80, in particular from 30 to 70, % by weight of styrene and from to 80, in particular from 30 to 70, % by weight of at least one C₁-C₁₀-alkyl ester of acrylic acid, such as n-butyl acrylate, ethyl acrylate or 2-ethylhexyl acrylate, based in each case on the total amount of the monomers A.

Typical copolymers of class II contain, as monomers A, based in each case on the total amount of the monomers A, from 30 to 85, preferably from 40 to 80, particularly preferably from 50 to 75, 15% by weight of styrene and from 15 to 70, preferably from 20 to 60, particularly preferably from 25 to 50, % by weight of butadiene it being possible for from 5 to 20% by weight of the abovementioned monomers A to be replaced by (meth)acrylates of C₁-C₈-alkanols and/or by acrylonitrile or methacrylonitrile.

Typical copolymers of class III contain, as monomers A, based in each case on the total amount of the monomers A, from 20 to 80, preferably from 30 to 70, % by weight of methyl methacrylate and at least one further, preferably one or two further, monomers selected from acrylates of C₁-C₁₀-alkanols, in particular n-butyl acrylate, 2-ethylhexyl acrylate and ethyl acrylate, and, if required, a methacrylate of a C₂-C₁₀-alkanol in a total amount of from 20 to 80, preferably from 30 to 70, % by weight, as polymerized units.

Typical copolymers of class IV contain, as monomers A, based in each case on the total amount of the monomers A, from 30 to 90, preferably from 40 to 80, particularly preferably from 50 to 75, % by weight of a vinyl ester of an aliphatic carboxylic acid, in particular vinyl acetate, and from 10 to 70, preferably from 20 to 60, particularly preferably from 25 to 50, % by weight of a C₂-C₆-olefin, in particular ethylene, and, if required, one or more further monomers selected from (meth)acrylates of C₁-C₁₀-alkanols, in an amount of from 1 to 15% by weight, as polymerized units.

Among the abovementioned polymers, the polymers of class I are particularly suitable.

Suitable monomers B are in principle all monomers which differ from the abovementioned monomers and are copolymerizable with the monomers A. Such monomers are known to a person skilled in the art and serve as a rule for modifying the properties of the polymer.

Preferred monomers B are selected from monoethylenically unsaturated mono- and dicarboxylic acids of 3 to 8 carbon atoms, in particular acrylic acid, methacrylic acid, itaconic acid, their amides, such as acrylamide and methacrylamide, their N-alkylolamides, such as N-methylolacrylamide and N-methylolmethacrylamide, their hydroxy C₁-C₄-alkyl esters, such as 2-hydroxyethyl acrylate, 2- and 3-hydroxypropyl acrylate, 4-hydroxybutyl acrylate, 2-hydroxyethyl methacrylate, 2- and 3-hydroxypropyl methacrylate, 4-hydroxybutyl methacrylate, and monoethylenically unsaturated monomers having oligoalkylene oxide chains, preferably having polyethylene oxide chains, with degrees of oligomerization preferably of from 2 to 200, e.g. monovinyl and monoallyl ethers of oligoethylene glycols, and esters of acrylic acid, of maleic acid or of methacrylic acid with oligoethylene glycols.

The proportion of the monomers having acid groups is preferably not more than 10, in particular not more than 5, e.g. from 0.1 to 5, % by weight, based on the monomers M. The proportion of hydroxyalkyl esters and monomers having oligoalkylene oxide chains, where present, is preferably from 0.1 to 20, in particular from 1 to 10, % by weight based on the monomers M. The proportion of the amides and N-alkylolamides, where present, is preferably from 0.1 to 5% by weight.

In addition to the abovementioned monomers B, other suitable monomers B are crosslinking monomers, such as glycidyl ethers and glycidyl esters, e.g. vinyl, allyl and methallyl glycidyl ether, glycidyl acrylate and methacrylate, the diacetonylamides of the abovementioned ethylenically unsaturated carboxylic acids, e.g. diacetone(meth)acrylamide, and the esters of acetyl acetic acid with the abovementioned hydroxyalkyl esters of ethylenically unsaturated carboxylic acids, e.g. acetylacetoxyethyl (meth)acrylate. Suitable monomers B are furthermore compounds which have two nonconjugated, ethylenically unsaturated bonds, for example the di- and oligoesters of polyhydric alcohols with α,β-monoethylenically unsaturated C₃-C₁₀-monocarboxylic acids, such as alkylene glycol diacrylates and dimethacrylates, e.g. ethylene glycol diacrylate, 1,3-butylene glycol diacrylate, 1,4-butylene glycol diacrylate, and propylene glycol diacrylate, and furthermore divinylbenzene, vinyl methacrylate, vinyl acrylate, allyl methacrylate, allyl acrylate, diallyl maleate, diallyl fumarate, methylenebisacrylamide, cyclopentadienyl acrylate, tricyclodecenyl (meth)acrylate,

N,N′-divinylimidazolin-2-one or triallyl cyanurate. Furthermore, vinyl silanes, e.g. vinyltrialkoxysilanes, are also suitable as monomers B.

In order to achieve a uniform distribution of the polymer in the clay mineral which forms the molding, it has proven useful to use the polymer in the form of finely divided particles. Finely divided polymers are understood as meaning those whose weight-average particle diameter d₅₀ is does not exceed 10 μm, in particular 2 μm. In particular, the weight-average particle diameter d₅₀ of the polymer particles is from 100 to 2000 nm. The weight-average particle diameter d₅₀ is understood as meaning the diameter at which 50% by weight of the polymer particles have a smaller diameter. The weight-average particle diameter of a polymer can be determined in a known manner using an aqueous dispersion of the particles by quasielastic light scattering or by measurement in an ultracentrifuge.

Polymers having such particle diameters are as a rule present in the form of aqueous polymer dispersions or in the form of powders which are obtainable from these dispersions by evaporating the water. For the production of the novel moldings polymers in the form of aqueous polymer dispersions, in particular those which are obtainable by free radical emulsion polymerization of the abovementioned ethylenically unsaturated monomers, are therefore preferred. Also preferred are polymer powders prepared therefrom and aqueous dispersions which are obtainable by redispersing the polymer powders in water. Processes for the preparation of aqueous polymer dispersions as well as for the preparation of polymer powders from aqueous polymer dispersions are widely described in the prior art (cf. for example D. Distler, Wassrige Polymerdispersionen, Wiley VCH, Weinheim 1999; H. Warson, Synthetic Resin Emulsions, Ernest Benn Ltd., London 1972, pages 193-242). Both aqueous polymer dispersions and the powders prepared therefrom are moreover commercially available, for example under the ACRONAL®, STYRONAL®, BUTOFAN® and STYROFAN® trade names of BASF-Aktiengesellschaft, Ludwigshafen, Germany.

The free radical, aqueous emulsion polymerization of the monomers M is effected at, preferably, from 20 to 120° C. in the presence of at least one surfactant and at least one, preferably water-soluble initiator which initiates the free radical polymerization.

Suitable initiators are azo compounds, organic or inorganic peroxides, salts of peroxodisulfuric acid and redox initiator systems. A salt of peroxodisulfuric acid, in particular a sodium, potassium or ammonium salt, or a redox initiator system which contains hydrogen peroxide or an organic peroxide, such as tert-butyl hydroperoxide, as the oxidizing agent and a sulfur compound, which is selected in particular from sodium bisulfite, sodium hydroxymethanesulfinate and the hydrogen sulfite adduct of acetone, as the reducing agent is preferably used.

Suitable surfactants are the emulsifiers and protective colloids usually used for emulsion polymerization. Preferred emulsifiers are anionic and nonionic emulsifiers, which, in contrast to the protective colloids, generally have a molecular weight of less than 2000 g/mol and are used in amounts of from up to 0.2 to 10, preferably from 0.5 to 5, % by weight, based on the polymer in the dispersion or on the monomers M to be polymerized.

The anionic initiators include alkali metal and ammonium salts of alkylsulfates (alkyl radical: C₈-C₂₀), of sulfuric monoesters of ethoxylated alkanols (degree of ethoxylation: from 2 to 50, alkyl radical: C₈ to C₂₀) and of ethoxylated alkylphenol (degree of ethoxylation: from 3 to 50, alkyl radical: C₄-C₂₀), of alkylsulfonic acids (alkyl radical: CB to C₂₀) and of alkylarylsulfonic acids, (alkyl radical: C₄-C₂₀). Further suitable anionic emulsifiers are described in Houben-Weyl, Methoden der organischen Chemie, Volume XIV/1, Makromolekulare Stoffe, Georg-Thieme-Verlag, Stuttgart, 1961, pages 192-208).

The anionic surfactants also include compounds of the formula I,

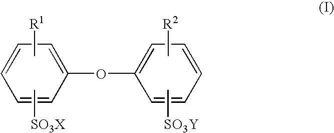

where R¹ and R² are each hydrogen or linear or branched alkyl of 6 to 18, in particular 6, 12, or 16, carbon atoms, R¹ and R² not both simultaneously being hydrogen. X and Y are each preferably sodium, potassium or ammonium, sodium being particularly preferred. Frequently, industrial mixtures which contain from 50 to 90% by weight of the monoalkylated product, for example Dowfax® 2A1 (registered trade mark of Dow Chemical Company) are used. The compounds I are generally known, for example from U.S. Pat. No. 4,269,749.

Suitable nonionic emulsifiers are araliphatic or aliphatic nonionic emulsifiers, for example ethoxylated mono-, di- and trialkylphenols (degree of ethoxylation: from 3 to 50, alkyl radical: C₄-C₉). Ethoxylates of long-chain alcohols (degree of ethoxylation: from 3 to 50, alkyl radical: C₈-C₃₆), and polyethylene oxide/polypropylene oxide block copolymers. Ethoxylates of long-chain alkanols (alkyl radical: C₁₀-C₂₂, average degree of ethoxylation: from 3 to 50) are preferred and those based on oxo alcohols and natural alcohols having a linear or branched C₁₂-C₁₈-alkyl radical and a degree of ethoxylation of from 8 to 50 are particularly preferred among these.

Anionic emulsifiers, in particular emulsifiers of the formula I, or combinations of at least one anionic and one nonionic emulsifier, are preferably used.

Suitable protective colloids are, for example, polyvinyl alcohols, starch derivatives and cellulose derivatives, carboxyl-containing polymers, such as homo- and copolymers of acrylic acid and/or of methacrylic acid with comonomers, such as styrene, olefins or hydroxyalkyl esters, or vinylpyrrolidone-containing homo- and copolymers. A detailed description of further suitable protective colloids is to be found in Houben-Weyl, Methoden der organischen Chemie, Volume XIV/1, Makromolekulare Stoffe, Georg-Thieme-Verlag, Stuttgart 1961, pages 411-420. Mixtures of emulsifiers and/or protective colloids may also be used.

Of course, the molecular weight of the polymers can be established by adding regulators in a small amount, as a rule up to 2% by weight, based on the polymerizing monomers M. Particularly suitable regulators are organic thio compounds, and furthermore allyl alcohols and aldehydes. In the preparation of the butadiene-containing polymers of class I, frequently regulators in an amount of from 0.1 to 2% by weight, preferably organic thio compounds, such as tert-dodecyl mercaptan, are used.

The emulsion polymerization can be carried out both continuously and by the batch procedure, but is preferably effected by a semicontinuous method. Here, the monomers to be polymerized are fed continuously to the polymerization batch, including by the step or gradient procedure. The monomers may be fed to the polymerization either as a monomer mixture or as an aqueous monomer emulsion.

In addition to the seed-free preparation procedure, the emulsion polymerization can be carried out by the seed latex method or in the presence of a seed latex prepared in situ, in order to established a defined polymer particle size. Relevant methods are known and are described in the prior art (cf. EP-B 40419 and

Encyclopedia of Polymer Science and Technology, Vol. 5, John Wiley & Sons Inc., New York 1966, page 847).

After the actual polymerization reaction, it may be necessary substantially to free the novel, aqueous polymer dispersions from odorous substances, such as residual monomers and other organic volatile components. This can be achieved physically in a manner known per se by removal by distillation (in particular by steam distillation) or by stripping with an inert gas. The reduction of the content of residual monomers can furthermore be effected chemically by free radical postpolymerization, in particular under the action of redox initiator systems, as described, for example, in DE-A 44 35 423, DE-A 44 19 518 and DE-A 44 35 422. Preferably, the postpolymerization is carried out using a redox initiator system comprising at least one organic peroxide and one organic sulfite.

After the end of the polymerization, the polymer dispersions used are frequently rendered alkaline, preferably brought to a pH of 20 from 7 to 10, before they are used according to the invention. For neutralization, ammonia or organic amines may be employed, and hydroxides, such as sodium hydroxide or calcium hydroxide are preferably used.

The production of the novel moldings can be carried out in a manner similar to the production of conventional moldings comprising clay ceramic materials, but a calcination step is not required. As a rule, the process for the production of the moldings comprises the following steps to be carried out in succession:

i) preparation of a plastically deformable, flowable or pulverulent material by mixing one or more clay mineral-containing materials with an aqueous dispersion of a hydrophobic film-forming polymer, or a polymer powder prepared therefrom, and water,

ii) molding of the material to give a moist molding and

iii) drying of the molding in order to remove the water.

Step i is carried out as a rule by simply mixing or homogenizing the components: water, clay mineral or clay mineral-containing mineral material and polymer, which are preferably used in the form of an aqueous polymer dispersion or of an aqueous redispersion of a polymer powder. The required amount of water is as a rule from 10 to 30% by weight, based on the mineral component, in the case of plastic materials and even higher, for example up to 50% by weight, for flowable materials. Pulverulent materials contain as a rule from 5 to 10% by weight, based on the mineral components of the material, of water.

The shaping procedure, in step ii, for the material obtained in step i depends on the viscosity of the material. In the case of pulverulent materials, the shaping is generally effected by compression molding of the material in suitable compression molds. The shaping of flowable materials is effected as a rule by casting methods. The processing of the plastic materials preferred according to the invention is effected, for example, by extrusion by means of extruders, preferably with application of reduced pressure in order to remove enclosed air pores, by means of coating presses or by means of punching presses (regarding the processing of the clay mineral-containing formulations, cf. Ullmanns Enzyklopädie der technischen Chemie, 3rd edition, Volume 17 page 486 et seq.).

The novel mineral moldings are finished in step iii by drying of the moist molding obtained in step ii, the water being removed and the novel molding acquiring its final strength. Step iii is carried out as a rule at from 20 to 150° C., preferably from 20 to 120° C., higher temperatures also being possible. Temperatures above 200° C. are not generally used, in order to avoid decomposition of the polymer. At below 10° C., the drying process is as a rule too slow to still be economical. With regard to the mechanical properties, in particular drying at above room temperature, for example from 50 to 150° C., in particular from 80 to 125° C., is advantageous. In particular, it has proven useful if the drying temperature during the drying process is varied in such a way that the drying temperature toward the end of the drying process is at least 20 K, in particular at least 40 K, e.g. from 40 to 120 K, above the drying temperature at the beginning of the drying process. In particular, the drying temperature is increased from an initial temperature which is in the region of ambient temperature initially to a first temperature which is at least 20 K, e.g. from 20 to 50 K, above ambient temperature and this temperature is maintained for from about 40 to 80% of the total duration of drying and is then increased to a second temperature, which is at least 10 K, preferably from 10 to 80 K, above the first temperature, until the drying is complete.

The conventional drying means, such as chamber drying ovens, drum driers, paddle driers and infrared driers, are suitable for drying (cf. Ullmanns Enzyklopädie der Technischen Chemie, 3rd Edition, Vol. 17, page 459 et seq.).

Surprisingly, in the case of the novel moldings, a calcination process is not required for achieving the final strength.

The novel moldings have high bending tensile strength and compressor strength and high elasticity in comparison with unmodified clay moldings. The shrinkage usually observed during the drying of moist, clay mineral-containing materials is not influenced or is adversely affected only to an insignificant extent, the shrinkage always occurring with dimensional stability and hence being of minor importance for the production of the molding.

It has proven advantageous if a pigmented, polymer-bound coating, preferably based on an aqueous polymer dispersion, is applied to a main surface of the novel moldings, in the case of the roof building blocks preferably to the side exposed to weathering.

This polymeric coating may be applied both before and after drying in step iii). Preferably, the polymer-bound coating material is applied prior to drying of the novel moldings, and the molding coated in this manner is then subjected to the setting process. The application can be effected in a manner known per se by spraying, troweling, knife-coating, roll-coating or casting.

Suitable coating materials are all polymer-bound coating materials of the prior art which are used for coating conventionally manufactured concrete roof tiles. These are in particular coating materials based on aqueous polymer dispersions of the abovementioned polymer classes I and III.

The polymers in the coating materials preferably have a glass transition temperature of from −20 to +80° C., in particular from 0 to +50° C. Their molecular structure is as a rule comparable with that of the polymers used for modifying the clay mineral-containing material.

Suitable coating materials, as described for coating conventionally manufactured concrete roof tiles, are mentioned in EP-A 469 295, EP-A 492 210, EP 355 028, EP 383 002, EP-A 941 977, DE-A 197 49 642, DE-A 198 10 050, DE-A 40 03 909 and DE-A 43 41 260. The coating materials described in the abovementioned patent applications as well as the coating methods described there for conventionally produced concrete roof tiles can all be applied to the novel moldings. To this extent, the disclosure of these publications is hereby incorporated by reference in its entirety.

The polymer-bound coating materials are applied as a rule in pigment-containing form, i.e. in the form of a color. Of course, they may also be applied in the form of a pigment-free formulation, i.e. in the form of a clearcoat, to the surface to be coated.

The polymer-bound coating materials can be applied in one layer or in a plurality of layers to that surface of the novel molding which is to be coated.

In a very particularly preferred embodiment of the novel process, a pigment-free coating material based on an aqueous polymer dispersion, preferably a pure acrylate dispersion or a styrene/acrylate dispersion, is applied to the novel molding, preferably in the moist state, in a first step. In a second step, a further, polymer-bound coating material, preferably based on a styrene/acrylate dispersion or a pure acrylate dispersion, is applied to the molding provided with a polymer-bound coating in this manner. The second coating material is formulated, as a rule, as a color, i.e. it contains colored pigments and, if requires, fillers. In such colors, the content of pigment plus filler is as a rule from 5 to 100% by weight, based on the polymer contained in the color. Further pigment-free or pigment-containing coating materials based on aqueous polymer dispersions or other polymers can be applied to this color coating. If the second polymer coating comprises a plurality of different polymer layers, the initially applied second coating contains as a rule more pigment than the subsequently applied further layers.

The amounts of the individual polymer coating materials applied are chosen as a rule in such a way that the first coating has a weight per unit area of from 50 to 500 g/m² and the second and further coatings have a total weight per unit area of from 50 to 500 g/m² (calculated relative to dry substance). The first coating serves as a primer or as an adhesion promoter for the second coating and the further coatings.

The use of a pigment-containing coating (color) has the advantage that the novel molding need not be colored right through with pigments but has the desired color only on the visible surfaces. This reduces costs on the one hand, since the amount of pigment required for achieving the colored appearance can be reduced by more than a half, and, on the other hand, increases the range of possible materials for use, some of which require the addition of pigment in order to be brought to the desired color. Surprisingly, it has not been possible to date to apply a color in the case of conventional clay ceramic moldings, since the color adhered only poorly.

The examples which follow illustrate the invention but do not impose any restriction.

I. Materials used

The mineral material used was a mixture of an illite-containing clay having a particle size of less than 2 μm and sand.

Polymer P1

Copolymer of 63 parts by weight of styrene and 32 parts by weight of butadiene, 2.5 parts by weight of acrylonitrile and 2.5 parts by weight of N-methylacrylamide, having a glass transition temperature of 17° C.

Polymer P1 was used in the form of 50% strength by weight aqueous polymer dispersion which was stabilized with 1% by weight of ethoxylated C₁₃ fatty alcohol (E08) and 1.5% by weight of the sodium salt of a sulfuric monoester of ethoxylated C₁₋₂ alcohol (E03). The polymer dispersion had a minimum film formation temperature of 16° C.

Polymer P2

Copolymer of 54 parts by weight of styrene and 46 parts by weight of 2-ethylhexyl acrylate and 2.6 parts by weight of acrylic acid, 1 part by weight of acrylamide and 0.5 part by weight of methacrylamide, having a glass transition temperature of 12° C., in the form of a 50% strength by weight aqueous polymer dispersion having a minimum film formation temperature of 20° C. For stabilization, the dispersion contained 0.4% by weight of nonylphenol ethoxylate (degree of ethoxylation 25) and 1.2% by weight of the sodium salt of the sulfuric monoester of nonylphenol ethoxylate (degree of ethoxylation 25).

Polymer P3

Copolymer of 62 parts by weight of styrene and 34 parts by weight of n-butyl acrylate, 1.5 parts by weight of acrylic acid and 2.5 parts by weight of N-methylolmethacrylamide, having a glass transition temperature of 34° C., in the form of a 50% strength by weight aqueous polymer dispersion having a minimum film formation temperature of 30° C.

II Test methods

The prisms which, in the moist state, measured 4 cm×4 cm×16 cm were tested. For the production of the prisms, 100 parts by weight of the clay mineral powder were mixed with 20 ml of water and a defined amount of the polymer dispersions P1, P2 or P3 to give a plastically deformable material. The material thus obtained was extruded by means of an extruder and divided into the pieces of the above-mentioned length by means of a knife. The amount of polymer dispersion was such that the polymer content was 3 parts by weight per 100 parts by weight of dry clay mineral. The samples were then dried either for 28 days at 23° C. and 50% relative humidity or for 24 hours at 105° C. The prisms thus obtained were investigated with regard to the bending tensile strength and compressive strength and with respect to the shrinkage during drying.

The bending tensile strength and compressive strength were measured according to DIN EN196.

The shrinkage was measured according to D. Knöfel and P. Schubert, Handbuch Mörtel und Steinerganzungsstoffe in der Denkmalpflege, Verlag Ernst und Sohn, Berlin 1993.

The results are shown in Tables 1 and 2.

TABLE 1
Unheated samples
Drying for 28 days under the conditions 23/50

| | E_{dyn} | | | |
|---|---|---|---|---|
| Sample | [N/mm²] | β_{C} [N/mm²] | β_{BT} [N/mm²] | ε_{S} [N/mm²] |
| Reference sample | 8 900 | 5.4 | 4.39 | 150 |
| Dispersion 1 | 11 200 | 19.7 | 12.51 | 158 |
| Dispersion 2 | 10 000 | 18.6 | 10.44 | 180 |
| Dispersion 3 | 9 400 | 19.7 | 11.42 | 219 |

E_{dyn} = dynamic modulus of elasticity
β_{C} = compressive strength
ε_{S} = shrinkage
β_{BT} = bending tensile strength

TABLE 2
Heated samples
Samples were heated for 28 h at 105° C.

| | E_{dyn} | | | |
|---|---|---|---|---|
| Sample | [N/mm²] | β_{C} [N/mm²] | β_{BT} [N/mm²] | ε_{S} [N/mm²] |
| Reference sample | 8 400 | 8.6 | 1.70(*) | 154 |
| Dispersion 1 | 15 700 | 23.8 | 14.56 | 155 |
| Dispersion 2 | 13 700 | 29.3 | 18.44 | 187 |
| Dispersion 3 | 12 300 | 30.8 | 19.32 | 218 |

E_{dyn} = dynamic modulus of elasticity
β_{C} = compressive strength
ε_{S} = shrinkage
β_{BT} = bending tensile strength
(*)The experiment was carried out only on one test specimen which already had cracks at the beginning of the experiment

The results in Table 1 and Table 2 show that even small amounts of polymer lead to a substantial improvement in the compressive strength and bending tensile strength. At same time, the use of polymer leads to a moderate to good improvement in the dynamic modulus of elasticity.

We claim:

1. A clay molding containing a mineral material based on clay minerals as the main component and at least one hydrophobic, film-forming polymer uniformly distributed in the molding.

2. A molding as claimed in claim 1, containing from 0.2 to 20 parts by weight, based on 100 parts by weight of mineral components, of polymer.

3. A molding as claimed in any of the preceding claims, wherein the polymer has a glass transition temperature of from −20 to +80° C.

4. A molding as claimed in any of the preceding claims, wherein the polymer is composed of ethylenically unsaturated monomers M comprising
from 80 to 99.5% by weight of ethylenically unsaturated monomers A having a water solubility of <60 g/l (25° C. and 1 bar)
from 0.5 to 20% by weight of monomers B differing from the monomers A,
all data in % by weight being based on 100% by weight of monomers M and it being possible for 30% by weight of the monomers A to be replaced by acrylonitrile and/or methacrylonitrile.

5. A molding as claimed in claim 4, wherein the polymers are selected from
I) copolymers which contain, as monomer A, styrene and at least one C₁-C₁₀-alkyl ester of acrylic acid, and if required, one or more C₁-C₁₀-alkyl esters of methacrylic acid as polymerized units;
II) copolymers which contain, as monomer A, styrene and at least one conjugated diene and, if required, (meth)acrylates of C₁-C₈-alkanols, acrylonitrile and/or methacrylonitrile as polymerized units;
III) copolymers which contain, as monomers A, methyl acrylate, at least one C₁-C₁₀-alkyl ester of acrylic acid and, if required, a C₂-C₁₀-alkyl ester of methacrylic acid as polymerized units;
IV) copolymers which contain, as monomer A, at least one vinyl ester of an aliphatic carboxylic acid of 2 to 10 carbon atoms and at least one C₂-C₆-olefin and, if required, one or more C₁-C₁₀-alkyl esters of acrylic acid and/or of methacrylic acid as polymerized units.

6. A molding as claimed in claim 4 or 5, wherein the monomers B are selected from monoethylenically unsaturated mono- and dicarboxylic acids of 3 to 8 carbon atoms, their amides, their N-alkylolamides, their hydroxy-C₁-C₄-alkyl esters and monoethylenically unsaturated monomers having oligoalkylene oxide chains.

7. A molding as claimed in any of the preceding claims, wherein the polymer is obtainable by free radical aqueous emulsion polymerization.

8. A molding obtainable by
i) preparation of a plastically deformable, flowable or pulverulent material by mixing one or more clay minerals with an aqueous dispersion of a hydrophobic film-forming polymer, or a polymer powder prepared therefrom, and water,
ii) molding of the plastic mixture to give a moist molding and
iii) drying of the molding in order to remove the water.

9. A molding as claimed in any of the preceding claims, in the form of a roof building block.

10. A molding as claimed in any of the preceding claims, which additionally has a polymer-bound pigment-containing coating on at least one of the main surfaces.

11. A process for the production of a molding as claimed in any of claims 1 to 10, comprising the following process steps:
i) preparation of a plastically deformable mixture by mixing one or more clay minerals with an aqueous dispersion of a hydrophobic film-forming polymer, or a polymer powder prepared therefrom, and water,
ii) molding of the plastic mixture to give a moist molding and
iii) drying of the molding in order to remove the water.

12. A process as claimed in claim 11, wherein the drying is carried out at from 20 to 150° C.

13. A process as claimed in claim 12, wherein the drying temperature at the beginning of the drying is at least 20 K below the drying temperature toward the end of the drying.

14. A process as claimed in any of claims 10 to 13, wherein a pigment-containing coating is additionally applied to at least one main surface of the molding, before or after the drying of the molding.
